(19) United States
(12) Patent Application Publication
(10) Pub. No.: US 2012/0085834 A1
(43) Pub. Date: Apr. 12, 2012

(54) Flame Tolerant Primary Nozzle Design

(76) Inventors: Abdul Rafey Khan, Greenville, SC (US); Thomas Edward Johnson, Greenville, SC (US)

(21) Appl. No.: 12/900,027

(22) Filed: Oct. 7, 2010

(51) Int. Cl. F02D 1/06; B05B 1/26

(52) U.S. Cl. 239/5; 239/502

(57) ABSTRACT

A fuel nozzle includes a nozzle cavity with a side wall defining an annular cavity, and swirler vanes arranged circumferentially around an outer surface of the nozzle cavity. A plurality of ports are formed in the side wall and are circumferentially spaced around the nozzle cavity. The ports provide fluid communication through the side wall. The plurality of ports are positioned and/or oriented such that fuel jets communicated through the side wall are communicated downstream of the swirler vanes.

### BACKGROUND OF THE INVENTION

The invention relates to a combustor fuel nozzle and, more particularly, to a combustor fuel nozzle including features to reduce flame holding risk inside primary fuel nozzle vanes on high reactivity low wobbe fuel operation.

Gas turbines are widely used in commercial operations for power generation. FIG. 1 illustrates a typical gas turbine 10 known in the art. As shown in FIG. 1, the gas turbine 10 generally includes a compressor 12 at the front, one or more combustors 14 around the middle, and a turbine 16 at the rear. The compressor 12 and the turbine 16 typically share a common rotor. The compressor 12 progressively compresses a working fluid and discharges the compressed working fluid to the combustors 14. The combustors 14 inject fuel into the flow of compressed working fluid and ignite the mixture to produce combustion gases having a high temperature, pressure, and velocity. The combustion gases exit the combustors 14 and flow to the turbine 16 where they expand to produce work.

FIG. 2 provides a simplified cross-section of a combustor 20 known in the art. A casing 22 surrounds the combustor 20 to contain the compressed working fluid from the compressor 12. Nozzles are arranged in an end cover, for example, with primary nozzles 28 radially arranged around a secondary nozzle 30 as shown in FIG. 2. A liner 32 downstream of the nozzles 28, 30 defines an upstream chamber 34 and a downstream chamber 36 separated by a venturi throat 38. The compressed working fluid from the compressor 12 flows between the casing 22 and the liner to the primary 28 and secondary 30 nozzles. The primary 28 and secondary 30 nozzles mix fuel with the compressed working fluid, and the mixture flows from the primary 28 and secondary 30 nozzles into the upstream 34 and downstream 36 chambers where combustion occurs.

During full speed base load operations, the flow rate of the fuel and compressed working fluid mixture through the primary 28 and secondary 30 nozzles is sufficiently high so that combustion occurs only in the downstream chamber 36. During reduced power operations, however, the primary nozzles 28 operate in a diffusion mode in which the flow rate of the fuel and compressed working fluid mixture from the primary nozzles 28 is reduced so that combustion of the fuel and the compressed working fluid mixture from the primary nozzles 28 occurs in the upstream chamber 34.

Lower reactivity fuels, such as natural gas, typically have lower flame speeds. Due to lower natural gas flame speed, the flow rate of the fuel and compressed working mixture from the primary nozzles 28 operated in diffusion mode is sufficiently high so that combustion in the upstream chamber 34 occurs at a sufficient distance from the primary nozzles 28 to prevent the combustion from excessively heating and/or melting the primary nozzles 28. However, higher reactivity fuels, such as synthetic gas, hydrogen, carbon monoxide, ethane, butane, propane, or mixtures of higher reactivity hydrocarbons, typically have higher flame speeds. Increased flame speed of the higher reactivity fuels moves the combustion in the upstream chamber 34 closer to the primary nozzles 28. Local flame temperature under diffusion mode operation in the upstream chamber 34 can be much greater than the melting point of the primary nozzle 28 materials. As a result, primary nozzles 28 operated in diffusion mode may experience excessive heating, resulting in premature and/or catastrophic failure.

Fuel ports are typically located between vanes to inject the fuel between the vanes into the incoming air. The space between the vanes is limited, and on high reactivity fuels, during diffusion mode operation, there are increased chances of flame holding in the fuel jets that can cause damage to the nozzles, thereby limiting the fuel flexibility of the combustion system.

### BRIEF DESCRIPTION OF THE INVENTION

In an exemplary embodiment, a fuel nozzle includes a nozzle cavity with a side wall and a front wall defining an annular cavity, and swirler vanes arranged circumferentially around an outer surface of the nozzle cavity. A plurality of ports are formed in one of the side wall and the front wall and are circumferentially spaced therearound. The plurality of ports provide fluid communication through the side wall or the front wall. The plurality of ports are at least one of positioned or oriented such that fuel jets defined in and communicated through the side wall or the front wall are communicated downstream of the swirler vanes.

In another exemplary embodiment, a fuel nozzle includes a nozzle cavity with a side wall defining an annular cavity, where the side wall is tapered such that the nozzle cavity is part-conical shaped. Swirler vanes are arranged circumferentially around an outer surface of the nozzle cavity. A plurality of ports are formed in the side wall and are circumferentially spaced therearound. The plurality of ports provide fluid communication through the side wall. The plurality of ports are oriented at an angle that is greater than 90° in an axial direction relative to the side wall.

In yet another exemplary embodiment, a method of reducing flame holding risk inside primary fuel nozzle vanes includes the steps of (a) forming a nozzle cavity including a side wall and defining an annular cavity; (b) arranging swirler vanes circumferentially around an outer surface of the nozzle cavity; and (c) forming a plurality of ports in the side wall and circumferentially spaced therearound, the plurality of ports providing fluid communication through the side wall, where the plurality of ports are at least one of positioned or oriented such that fuel jets defined in and communicated through the side wall are communicated downstream of the swirler vanes.

### BRIEF DESCRIPTION OF THE DRAWINGS

FIG. 1 is a simplified cross-section of a gas turbine;

FIG. 2 is a simplified cross-section of a combustor;

FIG. 3 is a cross-sectional view through an existing fuel nozzle;

FIG. 4 is a cross-sectional view showing a fuel nozzle with an axially extended length;

FIG. 5 is a cross-sectional view showing a fuel nozzle with fuel ports oriented at an angle;

FIG. 6 is a cross-sectional view showing a fuel nozzle with both an axially extended length and fuel ports oriented at an angle; and

FIG. 7 is cross-sectional view showing a fuel nozzle with fuel ports in the front face.

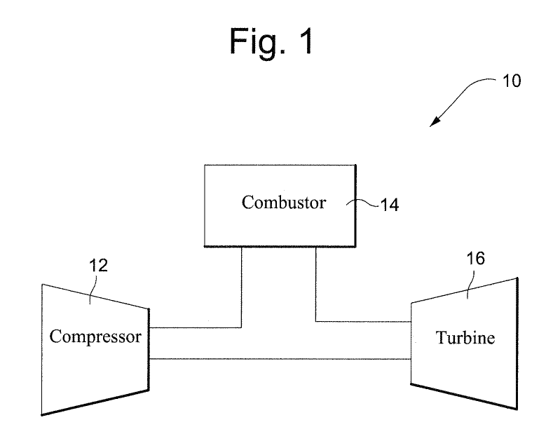

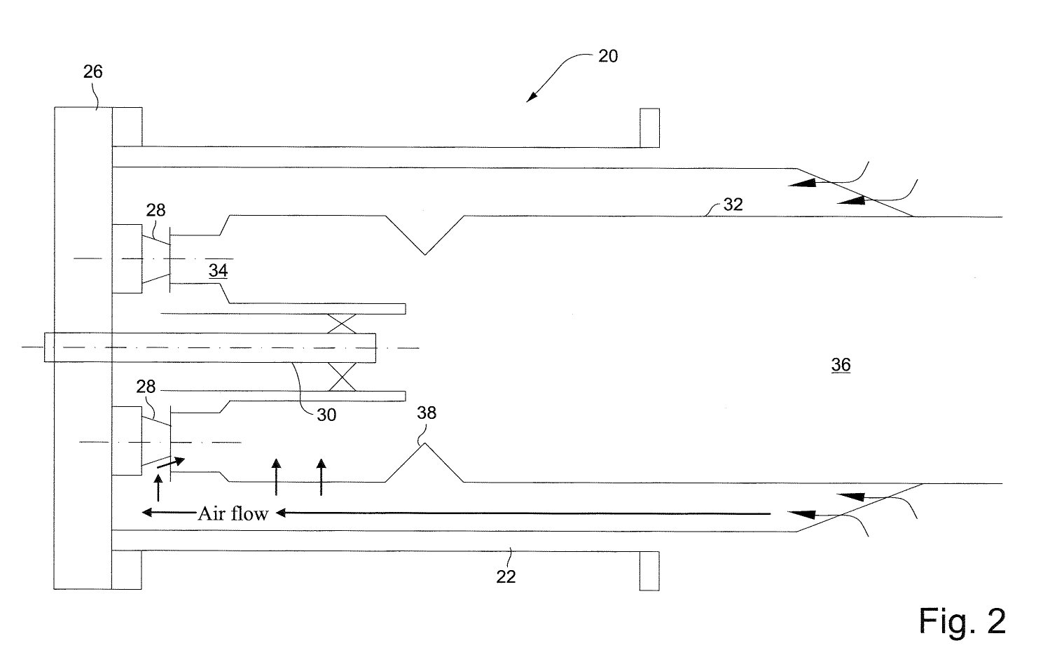

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

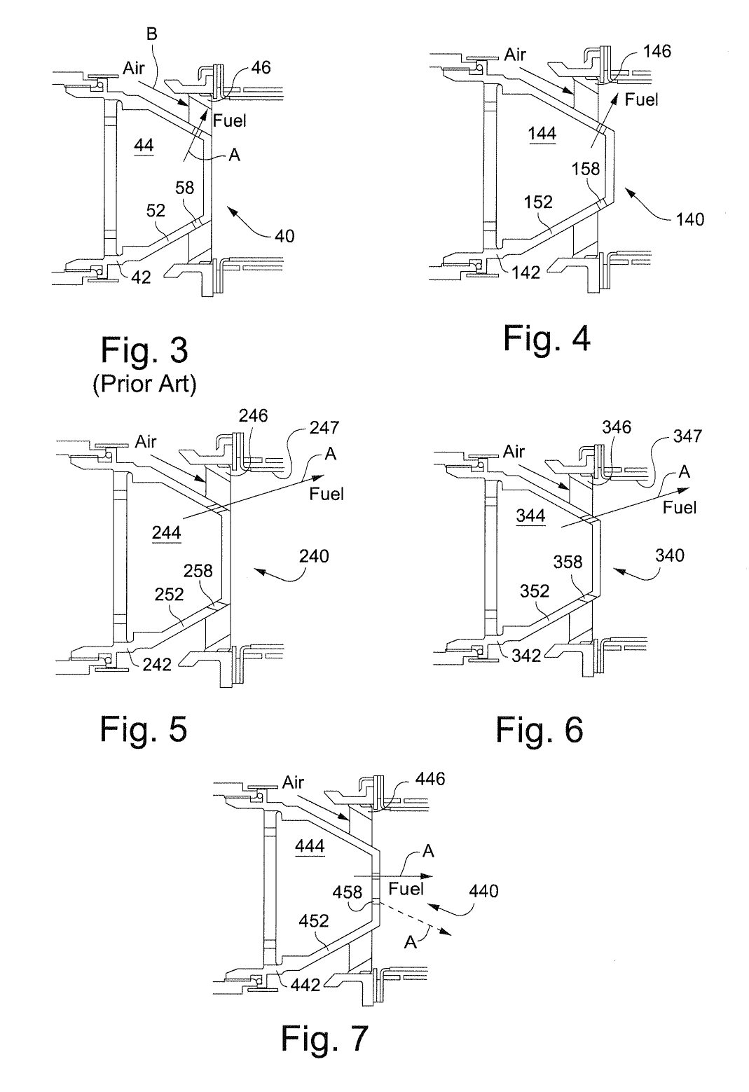

FIG. 3 shows a cross-section of a conventional nozzle 40. The nozzle 40 generally includes a nozzle body 42 defining an annular cavity 44 on the inside and swirler vanes 46 arranged circumferentially around the downstream, outer surface of the nozzle body 42. Fuel supplied to the nozzle body 42 flows through the annular cavity 44 and exits in the vicinity of the swirler vanes 46. Compressed working fluid from the compressor 12 mixes with the fuel from the annular cavity 44 and flows from the nozzle 40 into the upstream combustion chamber 34.

The nozzle body 42 includes a side wall 52 that defines a shape of the annular cavity 44. A plurality of orifices 58 or ports are formed in the side wall 52 and are circumferentially spaced around the side wall 52 to provide fluid communication through the side wall 52.

In the conventional construction, fuel in the annular cavity 44 is ejected via orifices 58 to mix with the air in the swirler vanes 46 (see arrows A and B in FIG. 3). As shown, the fuel ports are directed toward the surrounding hardware (vanes, burner tube, etc.), and flame holding particularly with high reactivity fuels can occur, thereby risking damage to the hardware.

With reference to FIGS. 4-7, the nozzle is modified such that the fuel ports are positioned and/or oriented such that fuel jets communicated through the nozzle sidewall (or front face—FIG. 7) are communicated downstream of the swirler vanes. In FIG. 4, the nozzle 140 is extended axially; that is, the sidewall 152 has an axial downstream length that extends axially beyond the swirler vanes 146. As shown, the fuel ports 158 are formed in a portion of the sidewall 152 that is downstream of the swirler vanes 146.

An alternative construction is shown in FIG. 5. In this embodiment, the fuel ports 258 are oriented at an angle such that the fuel jets are communicated downstream of the swirler vanes 246 (see arrow A in FIG. 5). FIG. 6 shows yet another construction combining the axially extending sidewall with the oriented fuel ports so that the ports 358 are positioned downstream of the swirler vanes 346 and the ports 358 are oriented at an angle such that the fuel jets are communicated still further downstream of the swirler vanes 346 (see arrow A in FIG. 6). The constructions shown in FIGS. 5 and 6 also serve to protect the nozzle burner tube 247, 347 by directing fuel farther downstream.

The ports 258, 358 may still further be oriented with a compound angle such that the fuel jets are communicated downstream of the swirler vanes 246, 346 and radially inward or outward. The compound angle promotes better mixing of the fuel and air prior to combustion.

The sidewall 152, 252, 352 is preferably tapered such that the nozzle cavity 144, 244, 344 is part-conical shaped. In the embodiment shown in FIG. 4, the fuel ports 158 are oriented at an angle that is about 90° in an axial direction relative to the sidewall 152. In the embodiments shown in FIGS. 5 and 6, the fuel ports 258, 358 are oriented at angles that are greater than 90° in an axial direction relative to the sidewall 252, 352.

FIG. 7 shows yet another alternative nozzle 440 where the fuel ports 458 are formed in a front face of the cavity 444 in the nozzle body 442 forward of the sidewall 452. The fuel can be directed straight through the front face (sold line arrow A) or at an angle (dashed line arrow A) downstream of the swirler vanes 446 (and the nozzle burner tube).

With the structure of the described embodiments, fuel jets are communicated downstream of swirler vanes to thereby reduce flame holding risk that can lead to hardware damage. The redirected fuel jets also reduce air blockage caused due to penetration of fuel jets, allowing more air for premixing. That is, as the fuel is injected outside of the swirler vanes, particularly for low wobbe fuels, the structure poses less blockage to the incoming swirler air intended for premixing. Air flow can also be reduced for very low reactivity wobbe fuels to allow more space for the fuel injection ports.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A fuel nozzle comprising:
a nozzle cavity including a side wall and a front wall defining an annular cavity;
swirler vanes arranged circumferentially around an outer surface of the nozzle cavity; and
a plurality of ports formed in one of the side wall and the front wall and circumferentially spaced therearound, the plurality of ports providing fluid communication through the side wall or the front wall, wherein the plurality of ports are at least one of positioned or oriented such that fuel jets defined in and communicated through the side wall or the front wall are communicated downstream of the swirler vanes.

2. A fuel nozzle according to claim 1, wherein the side wall comprises an axial downstream length that extends axially beyond the swirler vanes, and wherein the plurality of ports are formed in a portion of the side wall or the front wall that is downstream of the swirler vanes.

3. A fuel nozzle according to claim 2, wherein the plurality of ports are oriented at an angle such that the fuel jets are communicated downstream of the swirler vanes.

4. A fuel nozzle according to claim 3, wherein the plurality of ports are oriented with a compound angle such that the fuel jets are communicated downstream of the swirler vanes and radially inward or outward.

5. A fuel nozzle according to claim 1, wherein the plurality of ports are oriented at an angle such that the fuel jets are communicated downstream of the swirler vanes.

6. A fuel nozzle according to claim 1, wherein the side wall is tapered such that the nozzle cavity is part-conical shaped, and wherein the ports are oriented at an angle that is at least about 90° in an axial direction relative to the side wall.

7. A fuel nozzle according to claim 1, wherein the side wall is tapered such that the nozzle cavity is part-conical shaped, and wherein the ports are oriented at an angle that is greater than about 90° in an axial direction relative to the side wall.

8. A fuel nozzle according to claim 1, wherein the fuel jets communicated downstream of the swirler vanes define a space for at least one of premixing air and low reactivity wobbe fuels.

9. A fuel nozzle comprising:
a nozzle cavity including a side wall and a front wall defining an annular cavity, wherein the side wall is tapered such that the nozzle cavity is part-conical shaped;
swirler vanes arranged circumferentially around an outer surface of the nozzle cavity; and
a plurality of ports formed in the side wall and circumferentially spaced therearound, the plurality of ports providing fluid communication through the side wall, wherein the plurality of ports are oriented at an angle that is greater than about 90° in an axial direction relative to the side wall.

10. A fuel nozzle according to claim 9, wherein the side wall comprises an axial downstream length that extends axially beyond the swirler vanes, and wherein the plurality of ports are formed in a portion of the side wall that is downstream of the swirler vanes.

11. A fuel nozzle according to claim 10, wherein the plurality of ports are oriented with a compound angle such that the fuel jets are communicated downstream of the swirler and radially inward or outward.

12. A method of reducing flame holding risk inside primary fuel nozzle vanes, the method comprising:
(a) forming a nozzle cavity including a side wall and defining an annular cavity;
(b) arranging swirler vanes circumferentially around an outer surface of the nozzle cavity; and
(c) forming a plurality of ports in the side wall and circumferentially spaced therearound, the plurality of ports providing fluid communication through the side wall, wherein the plurality of ports are at least one of positioned or oriented such that fuel jets defined in and communicated through the side wall are communicated downstream of the swirler vanes.

13. A method according to claim 12, wherein the side wall comprises an axial downstream length that extends axially beyond the swirler vanes, and wherein step (c) is practiced by forming the plurality of ports in a portion of the side wall that is downstream of the swirler vanes.

14. A method according to claim 13, wherein step (c) is practiced by orienting the plurality of ports at an angle such that the fuel jets are communicated downstream of the swirler vanes.

15. A method according to claim 14, wherein step (c) is practiced by orienting the plurality of ports with a compound angle such that the fuel jets are communicated downstream of the swirler vanes and radially inward or outward.

16. A method according to claim 12, wherein step (c) is practiced by orienting the plurality of ports at an angle such that the fuel jets are communicated downstream of the swirler vanes.

17. A method according to claim 12, wherein the side wall is tapered such that the nozzle cavity is part-conical shaped, and wherein step (c) is practiced by orienting the ports at an angle that is at least about 90° in an axial direction relative to the side wall.

18. A method according to claim 12, wherein the side wall is tapered such that the nozzle cavity is part-conical shaped, and wherein step (c) is practiced by orienting the ports at an angle that is greater than about 90° in an axial direction relative to the side wall.

19. A method according to claim 12, wherein step (c) comprises reducing air blockage caused due to penetration of fuel jets, thereby allowing more air for premixing.
